(19) United States
(12) Patent Application Publication
(10) Pub. No.: US 2005/0108563 A1
(43) Pub. Date: May 19, 2005

(54) Protocol for controlling the mode of accessing data transmitted in point-to-point or point-to-multipoint mode

(76) Inventors: Claudia Becker, Rennes (FR); Chantal Guionnet, Cesson Sevigne (FR); Andre Codet, Rennes (FR); Pierre Fevrier, Saint Sulpice La Foret (FR)

Correspondence Address: STITES & HARBISON PLLC, 1199 NORTH FAIRFAX STREET, SUITE 900, ALEXANDRIA, VA, 22314, US

(21) Appl. No.: 10/498,320

(22) PCT Filed: Dec. 9, 2002
(86) PCT No.: PCT/FR02/04237

(30) Foreign Application Priority Data
Dec. 12, 2001 (FR) 01/16059

(51) Int. Cl. H04L 9/32

(52) U.S. Cl. 713/200

(57) ABSTRACT

The invention relates to a protocol for controlling the mode of access to data on the basis of rights, access criteria and electronic token carriers. Each access right and electronic token carrier are established (A) in the form of a group of variables comprising independent variables containing at least one variable for the duration of validity and one variable for identifying the access right or the electronic token carrier, and each access criterion is established (B) in accordance with another group of variables comprising independent variables containing at least one variable for the access date, one variable for identifying the type of access criteria and identifying the access right. A proposition for the mode of access is established (C) in order to define access restrictions and this proposition is subjected (D) to an evaluation of the access restrictions in comparison with the access rights. The mode of access is accepted for the true value of the evaluation and is not continued otherwise. Use for controlling the mode of access to data transmitted by point-to-point/multipoint transmission.

The invention relates to a protocol for controlling the mode of access to data and the use of such a protocol for operations for controlling access to these data in the field of transactions or electronic commerce.

In more specific terms, it will be appreciated that the above-mentioned data and the information supported by the data can be transmitted without encryption or, conversely, encrypted or scrambled. The encryption or scrambling of these data allows more strict control of access to be ensured, access to the scrambled or encrypted data being able to be completely prohibited.

Control of access to data, in particular when they are encrypted or scrambled, has experienced an unprecedented expansion through the advent of techniques for transmitting information by networks.

These techniques were originally proposed on a large scale in the field of applications in the transmission and display of information on television receivers for information, entertainment or other purposes.

In particular, a system for controlling access used in systems such as the “ANTIOPE” and “TITAN” systems has been proposed in French patent application 7902995 (2448825) disclosed to the public on 5^{th} Sep. 1980. The above-mentioned system for control of access uses a double key system comprising a service key, which allows information to be locked, this service key being changed randomly at short intervals of a few minutes, and a subscription key which can assume several Ci values according to the type of subscription. The subscription key also changes in a random manner at longer intervals in the order of a month. The key is registered on a subscription support element, such as a microprocessor card or credit card, this support being introduced into a receiving station. Specific messages composed when transmitted and transmitted with the locked or scrambled data allow, in the receiving station, the service key to be reconstituted and then the transmitted scrambled information to be unlocked, that is to say, unscrambled.

A number of developments in the above-mentioned process have given rise to the establishment of standard UTE C90-007 “System of conditional access for digital broadcasting systems”.

Access control systems which comply with the provisions of the above-mentioned standard allow the remote management of control of access to data to be ensured, which data are scrambled by means of a service key and transmitted between a transmission centre and at least one receiving station. The transmission centre comprises a module for calculating a control word CW which contains at least the service key and a module for encoding the control word by means of an operation key SOK in order to generate a cryptogram of the control word.

The management of the access control is carried out on the basis of access rights or entitlements which are registered on the subscription support and parameters for controlling the access entitlements or access criteria which are generated from the transmission centre.

To this end, there are provided a generator for control messages for the access entitlements, ECM messages (=Entitlement Control Message), containing at least the cryptogram of the control word and parameters for controlling access entitlement, which are designated access criteria, and a module for generating a message for managing access entitlements, EMM messages (=Entitlement Management Message). The ECM messages and the EMM messages can be multiplexed in the flow of scrambled information transmitted.

Each receiving station comprises at least one terminal for unscrambling the scrambled data and one access control module which comprises a security processor which is accommodated, for example, by an access control card which acts as a subscription support and which is introduced into the terminal. The security processor comprises the operation key SOK and access entitlements which are stored in the secure internal memory and a decoding module. The security processor allows the service key to be reconstituted, starting from the operation key and the cryptogram of the control word, based on a criterion for verifying at least one of the registered access entitlements on the basis of the access criteria transmitted.

Each unscrambling terminal comprises an unscrambling module which allows the scrambled data transmitted to be unscrambled, on the basis of the reconstituted service key, for use by the authorised subscribing user who holds the subscription support.

Such systems are satisfactory, in particular owing to the fact that the process for managing access entitlements by means of the transmitted EMM messages, on the one hand, and the control of these access entitlements on the basis of the access criteria, on the other hand, in order to authorise or deny continued access by unscrambling scrambled information is completely independent of the scrambling/unscrambling process itself.

Such a feature of independence allows in particular the subscriptions of subscribers and/or groups of subscribers to be managed independently of the management of the operation key SOK, which can then be modified by the authorities responsible for ensuring the operation of the access control system on the basis of criteria relating only to the securing of the data transmitted in order to ensure that this operation key is not compromised, and consequently the cryptogram of the control word, then ultimately the scrambled data.

To this end, the above-mentioned standard UTE C90-007 provides a system for addressing EMM messages in accordance with a group addressing system. Each subscriber therefore has, independently of the conditional access process itself, a group address which is attached to a service identifier. On the basis of this address, the authorities responsible for the operation of the access control system, the broadcasting operator, can deselect or select one or more groups. The addressing system associated with the service identifier parameter has the highest level of priority. When a user belongs to a deselected group, for example, he cannot access the scrambled data, whatever valid access entitlements he may otherwise possess, on the one hand, and the valid operation key which he holds, on the other hand.

The above-mentioned access rights or entitlements, which are registered and transmitted, in fact determine the continuation of the access control within the above-mentioned priority process.

However, the access entitlements, within the scope of strict compliance with the standard UTE C90-007, allow modes of access to be defined limited to:
subscription by theme/level;
subscription by list;
reservation of session intervals;
impulse purchase by programme;
impulse purchase by time unit;
previsualisation or “preview” purchase.

For a more detailed description of the previous access modes, reference could advantageously be made to the text of the above-mentioned standard, in particular to Section 2.3 “System Functionalities”, Paragraph 2.3.1, “Access Modes”, pages 10 and 11.

In practice, the above-mentioned access modes appear to be substantially partitioned. In particular, owing to the very definition and encoding thereof, they do not allow a user who has acquired access entitlements for reservation of session intervals to access scrambled data which is transmitted in access mode by means, for example, of impulse purchase. Within the scope of strict compliance with the provisions of the above-mentioned standard, the transmission of ECM messages comprising control parameters for access rights or access criteria corresponding to one of the preceding access modes, assigns a corresponding access mode to any transmission of a programme or scrambled data, independently of the process itself for scrambling the above-mentioned data.

Furthermore, the broadcasting operators request new access modes which, not being listed in the text of the above-mentioned standard, cannot therefore be applied in the absence of a definition and a specific encoding thereof.

Access modes of this type relate, for example, to:
access to a plurality N of broadcasts of an identical programme which is broadcast on television;
the dynamic selection by the user of N programmes from M programmes, M>N, which can be selected;
the possibility, in access mode by means of impulse purchase, of specific processing of the allocation of access to the scrambled data in accordance with the specific nature of the client user and/or the application associated with the accessed data;
access by means of fee according to a limited access time for a specific period of programmes broadcast on television;
access in impulse mode with a limited global cost.

The new access modes mentioned above are not limiting.

In particular, to this end, the subject-matter of the present invention is the implementation of a protocol for controlling the mode of access to data based on specifically encoded or defined access rights or entitlements and access criteria which allow the implementation of the greatest possible variety of access modes and/or combinations of access modes.

The present invention, owing to the diversity and the flexibility of the access modes which can be defined, encoded and implemented in accordance with the protocol for controlling the access mode according to the invention, also relates to the application of a protocol of this type to the access to data of any type, scrambled or non-scrambled, the method for defining and encoding access entitlements and criteria allowing the protocol which is the subject-matter of the invention to be adapted and applied to any kind of information.

The present invention also relates to the implementation of a protocol for controlling the mode of access to data, based on access rights or entitlements and access criteria which are subjected to a condition of validity of at least one access right or of an electronic token carrier for access values.

The protocol for controlling the mode of access to data based on access rights and access criteria which are subjected to a condition of validity of at least one access right or an electronic token carrier for access values, which is the subject-matter of the present invention, is notable in that it consists in establishing each access right and each electronic token carrier for access values, which is acquired by an authorised user, in the form of a first group of variables constituted by independent variables and linked variables. The independent variables of this first group contain at least one validity duration variable and one identification number variable for each access right or entitlement or each electronic token carrier, respectively. It further consists in establishing each access criterion in the form of a second group of variables constituted by independent variables and linked variables. The independent variables of this second group contain at least one access date variable, one identification variable for the access criterion type and one identification number variable for the access right or electronic token carrier and, in the case of an electronic token carrier, an access cost variable.

It also consists in establishing a proposition for the mode of access to the data in the form of a logic combination group for access criteria in order to generate access restrictions.

Finally, it consists in subjecting the access mode proposition to an evaluation of the access restrictions in comparison with the access rights or entitlements and electronic token carriers with acquired access values. The access mode is accepted and access to the data is continued for the true value of the evaluation and the access mode and access to the data is not continued otherwise.

The protocol which is the subject-matter of the present invention is used in the payment-based point-to-point or point/multipoint transmission of data, whether the data are encrypted or scrambled or not.

It is in particular used for controlling access to digital data, support for multimedia work, in the form of audio and/or video files, encrypted and unencrypted, the transmission being a point-to-point transmission between a remote client terminal and a central server, in accordance, for example, with the IP protocol.

Furthermore, the protocol which is the subject-matter of the present invention is used for controlling access to televised or broadcast programmes, in point/multipoint transmission, when the digital data which supports these programmes are scrambled or encrypted. The transmission, in the latter case, can be carried out by means of a radio network, terrestrial cable network or IP network.

The protocol will be better understood from a reading of the description and an examination of the drawings below, in which:

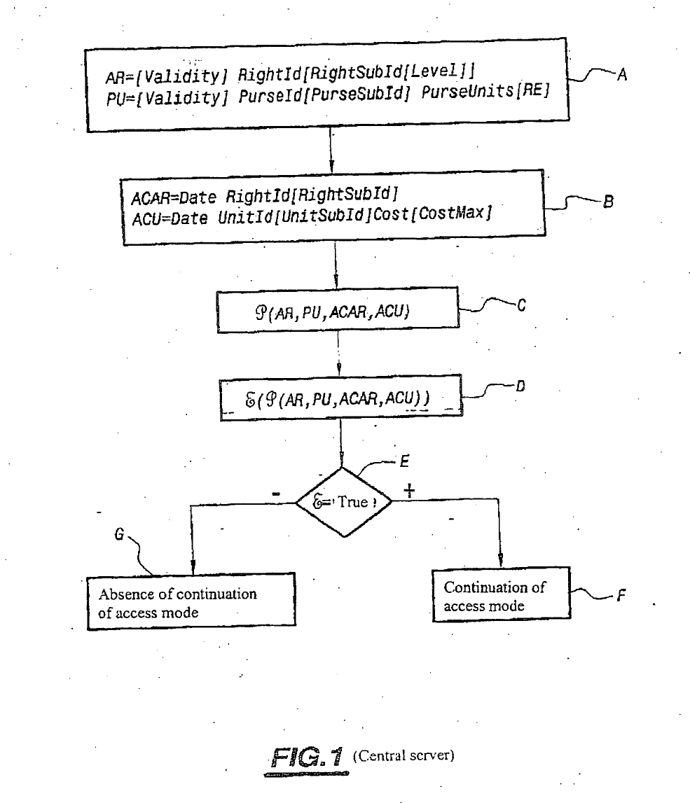

FIG. 1 illustrates, by way of example, an example of use of the protocol, which is the subject-matter of the present invention, in a central server, the transmission of the data to which access is allowed being able to be carried out, following the verification of the access mode, by means of a network using the IP protocol, for example;

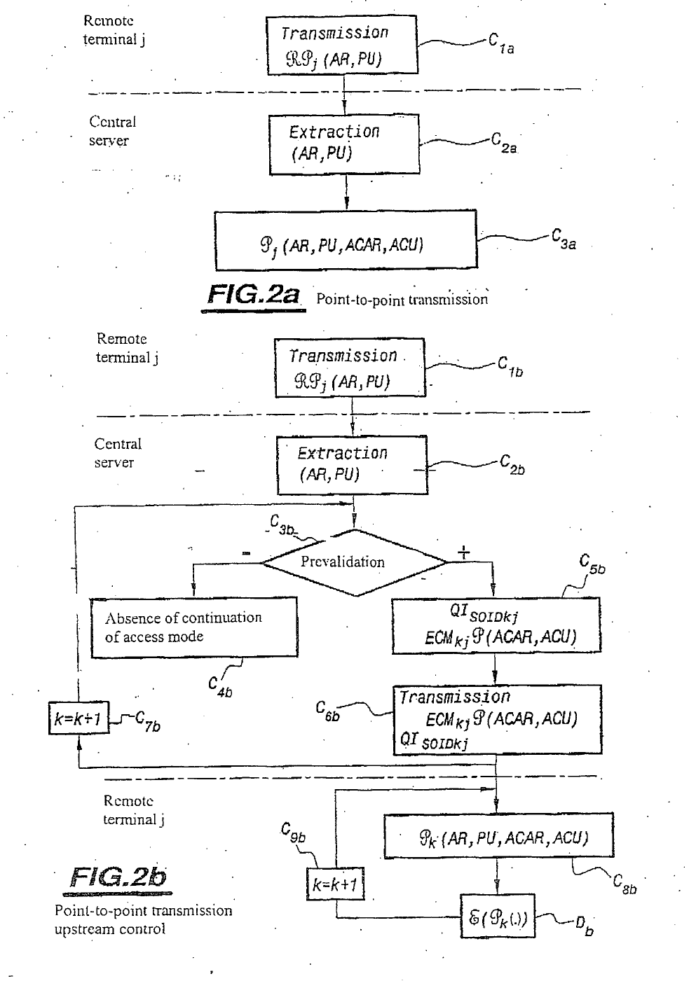

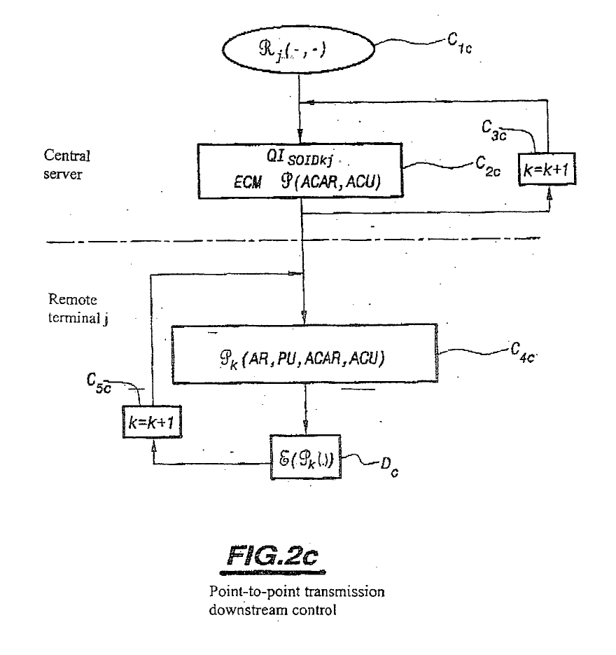

FIG. 2a illustrates, by way of example, a first variant of the use of the protocol which is the subject-matter of the present invention shown in FIG. 1, the remote client terminal having access rights and one or more specific electronic token carriers, from which a request for proposition of the access mode can be transmitted to the central server;

FIG. 2b illustrates, by way of example, a second variant of the use of the protocol which is the subject-matter of the present invention, as shown in FIG. 2a, in which the data to which access is requested are divided into quantities of data, following a prevalidation of the request for proposition of the access mode, and a control message containing specific access criteria associated with a current quantity of data are transmitted to the remote terminal, the operation for controlling the access mode itself then being used at the relevant remote terminal for each quantity of data and for the control message associated therewith;

FIG. 2c illustrates, by way of example, a third variant of use of the protocol which is the subject-matter of the present invention, corresponding to a simplification of the second variant according to FIG. 2b, in which, following authentification of the request for proposition of the access mode, the prevalidation step is dispensed with, the controlling of the access mode instead being carried out at the remote terminal, in a similar manner to that of FIG. 2b;

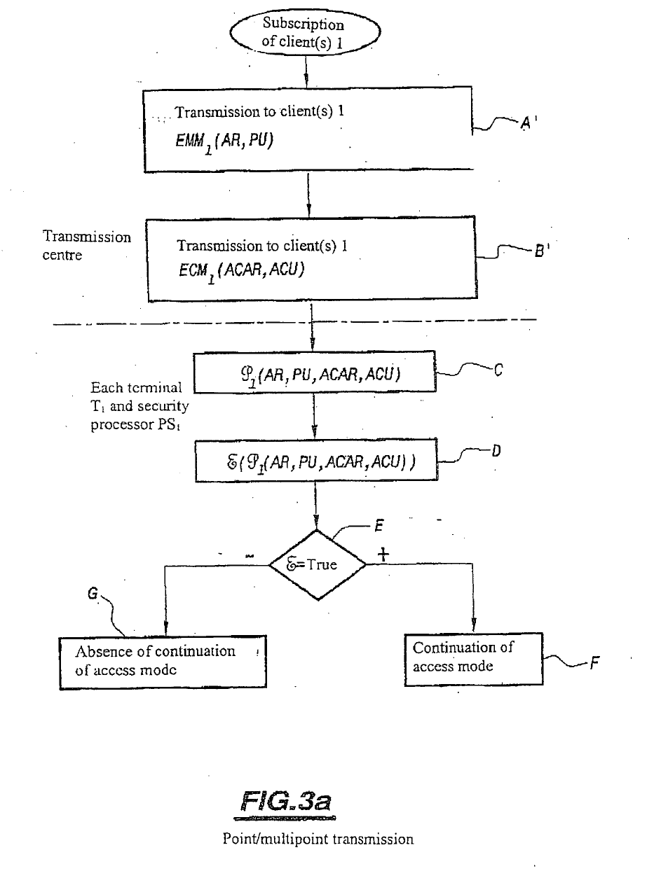

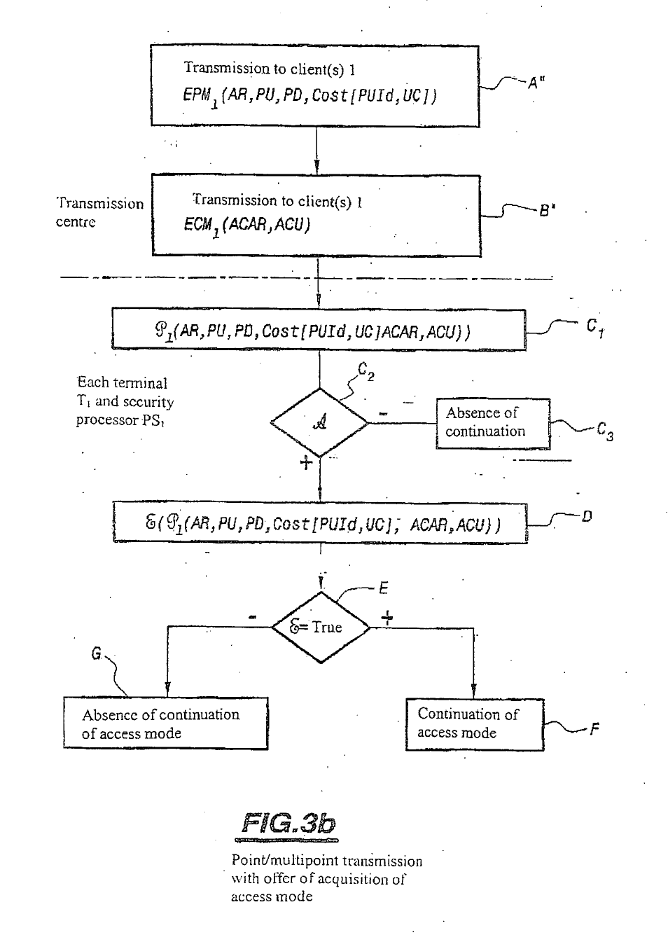

FIG. 3a illustrates, by way of example, another example of use of the protocol which is the subject-matter of the present invention, the transmission of the data to which access is requested being carried out in accordance with a point/multipoint mode, based on a broadcasting network, between a transmission centre and at least one terminal which ensures that the data are unscrambled when they are scrambled, an access control module equipped with a security processor being associated with the above-mentioned terminal;

FIG. 3b illustrates, by way of example, an advantageous variant of use of the protocol which is the subject-matter of the present invention according to FIG. 3a, in which, in the absence of any request for proposition of access, a message offering acquisition of a specific access mode is transmitted, initiated by the transmission centre or central server;

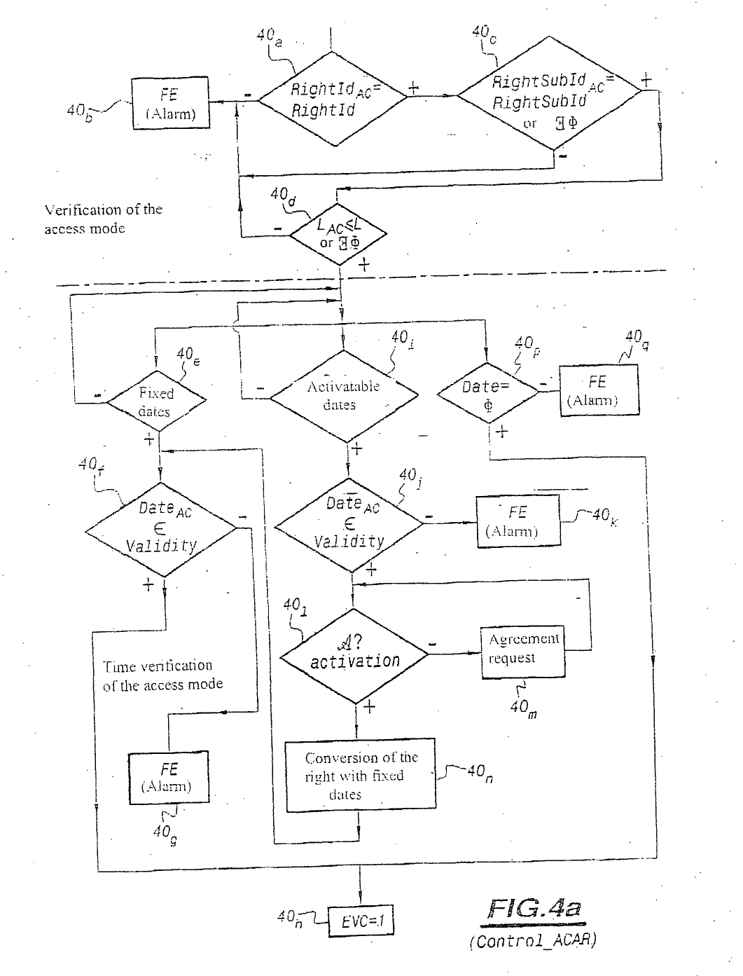

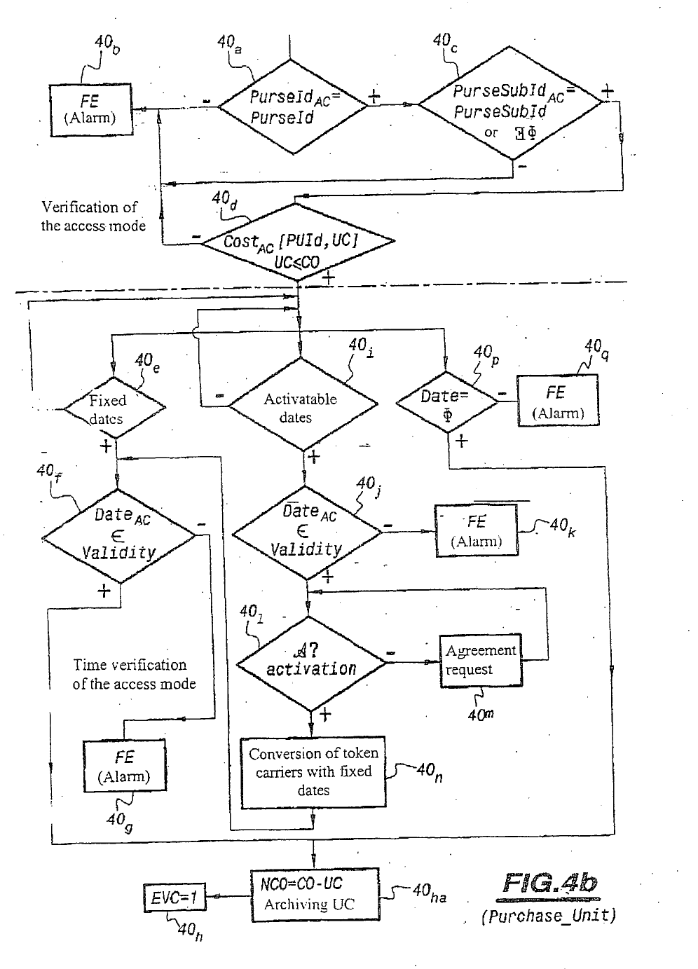

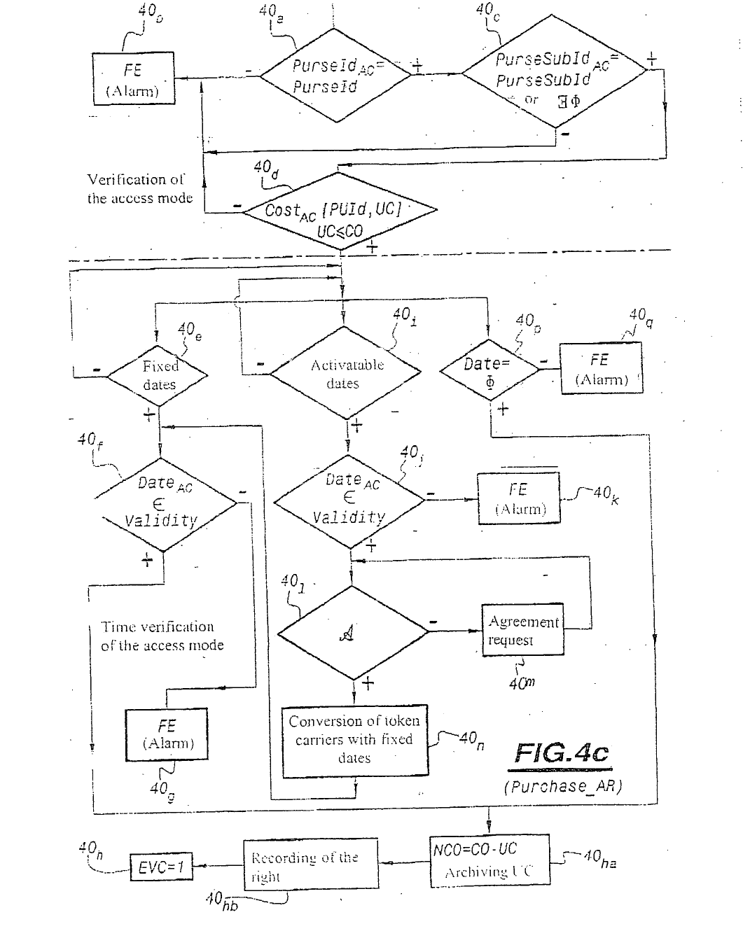

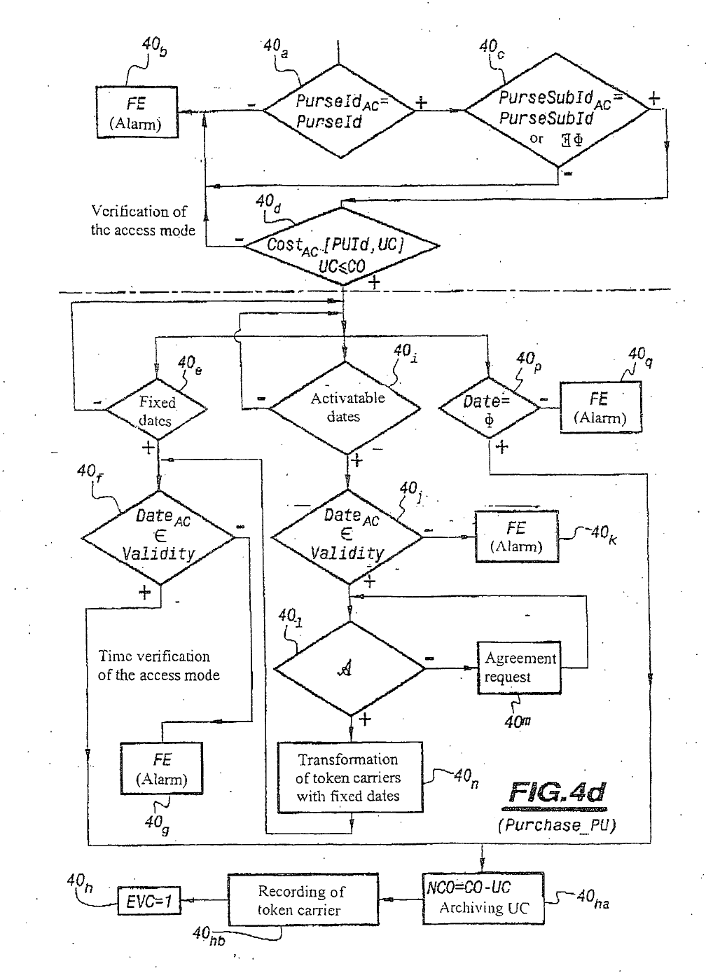

FIG. 4a illustrates, by way of example, a flow chart for controlling the access mode to an access right required by the subscribing user, the above-mentioned access right being able to be registered either at a remote terminal in the case of point-to-point transmission or in an access control module associated with an unscrambling terminal in the case of point/multipoint transmission;

FIG. 4b illustrates, by way of example, a flow chart for controlling the access mode during the acquisition of an access unit which is intended for an electronic token carrier, this acquisition being proposed in point type mode in the case of point-to-point transmission or in pulse type mode in the case of point/multipoint transmission;

FIG. 4c illustrates, by way of example, a flow chart for controlling the access mode during the acquisition of an access right which is intended for an electronic token carrier, this acquisition being proposed in point type mode in the case of point-to-point transmission or in pulse type mode in the case of point/multipoint transmission;

FIG. 4d illustrates, by way of example, a flow chart for controlling the access mode during the acquisition of a new electronic token carrier, this acquisition being proposed in point type mode in the case of point-to-point transmission or in pulse type mode in the case of point/multipoint transmission;

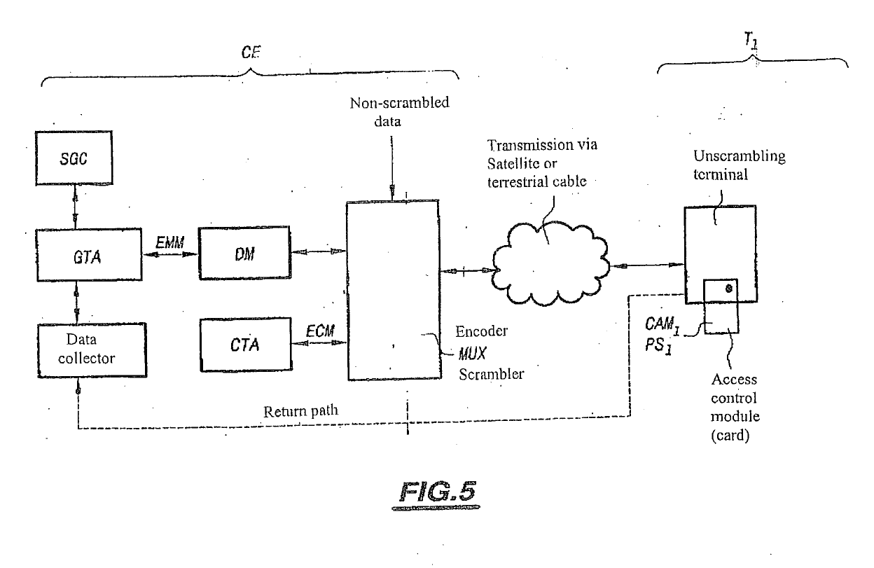

FIG. 5 is, by way of example, a schematic illustration of an installation, a transmission centre, which allows the combination of two access conditions in accordance with an access mode by acquisition of a fee in pulse type mode or access mode based on an existing fee, accompanied by a statement of consumption of access units by the subscriber, in the case of a transmission in point/multipoint mode, the transmitted data further being scrambled.

A more detailed description of the protocol which is the subject-matter of the present invention will now be given with reference to FIG. 1 and the following Figures.

Generally, it should be noted that the protocol which is the subject-matter of the present invention can be used, on the one hand, when the data requiring access are transmitted in point-to-point mode between a central server and a remote terminal, the transmission of the above-mentioned data being carried out, by way of non-limiting example, according to the IP protocol, for example.

In such a situation, it should be noted that the subscribing user has been able to register a user right or subscription to a service at the central server, this service being of any type, such as commerce or electronic transactions, the corresponding service provisions being carried out in the form of exchanges of data to which the authorised subscribing user requests access.

Access to the service is therefore carried out, subject to payment, based on access rights and access criteria, the control of the access mode being subjected to a condition of validity of at least one of the above-mentioned access rights which the authorised subscribing user enjoys or an electronic token carrier, for example.

Generally, it is indicated that the protocol for controlling the mode of access to these data, in accordance with the subject-matter of the present invention, can be completely implemented at the central server in the circumstances which will be explained below with reference to FIG. 1.

In order to manage the control of the mode of access to the above-mentioned data, the protocol which is the subject-matter of the present invention advantageously consists in establishing each access right and each electronic token carrier acquired by the authorised user or subscriber in the form of a first group of variables constituted by independent variables and linked variables.

The establishment step of each access right is illustrated in step A of FIG. 1, the access rights being designated AR and the electronic token carrier being designated PU, each verifying the relationship (1):
AR=[Validity] RightId [RightSubId [Level]] (1)
PU=[Validity] PurseId [PurseSubId] PurseUnits [RE]

The encoding of the access rights AR and the electronic token carriers PU, in accordance with the subject-matter of the present invention, allows the access rights and the electronic token carriers to be given a generic character in so far as the independent variables contain at least one validity duration variable and one identification number variable for each access right or for each electronic token carrier and, in the case of the electronic token carriers, a unit credit variable.

Generally, it should also be noted that, in accordance with the specific encoding of the access rights AR and the electronic token carriers PU, it is indicated that any variable between square brackets is considered to be optional. In this manner, with reference to the relationship (1), it is indicated that the variables:
Validity: indicates a validity period which can be fixed and illustrated by a start date and end date for the access right, or which can be sliding and thus defined by a number of days or lapsing date. The validity period can then be changed into a fixed value, for example, at the first time of use.

It will be appreciated that the validity variable is optional. When the validity variable field is empty, the validity variable not being encoded, the access right is still valid. An encoding method of this type corresponds, for example, to the attribution of a permanent right in accordance with the selections of the broadcasting operator or the central server.
RightId, RightSubId: the above-mentioned variables correspond to identifiers and subidentifiers of a right which in particular allow this right to be referenced in the access criteria. It will be appreciated in particular that, with the identifier being a compulsory independent variable and the subidentifier being optional, the identifier RightId allows the same family of services to be referenced for an operator, such as, for example, a service for access to games, and the subidentifier RightSubId allows a game within this family to be referenced, if necessary, one or more games.
Level: the above-mentioned variable defines a level value which represents a maximum access position for the right in question.
PurseID and PurseSubId: designate variables of identifiers or subidentifiers of an electronic token carrier which in particular allow this electronic token carrier to be referenced during any transaction and, in particular, any point type transaction, an electronic token carrier or, if necessary, an electronic purse being able to be attributed to a specific transaction, as will be described below in the description.

According to a particularly advantageous aspect of the protocol which is the subject-matter of the present invention, it will be appreciated, with reference to the relationship (1), that, in the same manner as the access rights, the electronic token carrier comprises the same independent variables of validity duration and identification of the electronic token carrier as those which allow the access rights AR to be defined.

Furthermore, the electronic token carrier comprises the following variables:
PurseUnits: this variable defines the amount, in access value, of the electronic token carrier associated with the access rights of the authorised user. The unit of such an access amount can be different from one electronic token carrier or purse to another, with different identifiers, that is to say, different access values or unit values for the access count.
RE: represents a variable which is linked to the independent variable PurseUnits, the variable RE designating a so-called report variable which allows the content of the relevant electronic token carrier, or the credit balance thereof, to be reported to a token carrier of the same type or to the same purse or electronic token carrier which comprises an identical identifier.

Generally, it is indicated that the variable RE is optional and that it can further comprise a limit date for report of the token carrier, designated Rdate, and a maximum report variable for the token carrier, designated RPurse.

The protocol which is the subject-matter of the present invention also consists in establishing each access criterion in the form of a second group of variables constituted by independent variables and linked variables, this step being shown in step B of FIG. 1.

The independent variables of the access criteria contain at least one access date variable, designated Date, one variable for identifying the type of access criterion and one linked variable in the type of access criteria, the variable for identification in the type of access criteria corresponding to a numerical variable for identification of the access rights or electronic token carrier, as will be described below.

In this manner, with reference to FIG. 1, the access criteria advantageously comprise the following access criteria which verify the relationship (2):
Criterion per nominal access right designated ACAR:
ACAR=Date RightId [RightsubId [Level]]
Criterion per unit of accessed quantity of data and in correlation with the data consumed in an electronic token carrier ACU:
ACU=Date UnitId [UnitSubId] Cost [CostMax] (2)

In the relationship above, the above-mentioned variables designate:
Date: date of the access criterion. The date must be within the validity period of the access right AR or the electronic token carrier PU which is used.
UnitId UnitSubId: identification variable and subidentification variable for an access unit which allows an accumulation of access units, in particular for a statement or a subsequent consultation of the consumptions of each electronic token carrier.
Cost: variable for cost of the point type acquisition, the variable Cost being able to be a complex variable which verifies the relationship:
Cost=CostId PurseId [PurseSubId] CostUnits

In the relationship above, CostId designates the identifier of the acquisition, CostUnits designates the cost of the point type acquisition in a specific electronic token carrier.
CostMax: variable of maximum cost, designates a ceiling from which the criterion is verified with authorisation or refusal of access. The costs of all the consumptions of the same identifier and subidentifer of the accessed criterion are accumulated, for example, in order to be compared with this ceiling.

The protocol which is the subject-matter of the present invention then consists, in step C, in establishing a proposition for the mode of access to the data in the form of a logic combination group for an access criterion in order to define access restrictions.

The proposition for the mode of access verifies the relationship (3):
P (AR,PU,ACAR,ACU) (3)

It will be appreciated that, based on the access rights AR of the electronic token carrier(s) PU and the previously defined access criteria ACAR, ACU and, of course, a request formulated by the authorised subscriber, the implementation of the rules of comparison between the variables of access criteria and the access rights effectively acquired by the registered subscriber allows the access proposition to be established according to the above-mentioned relationship (3).

Step C is then followed by a step D which consists in subjecting the access mode proposition P to an evaluation of the access restrictions in comparison with the access rights and the electronic token carriers acquired. The operation of the step D verifies the relationship (4):
E (P(AR, PU, ACAR, ACU)) (4)

Step D is then followed by a step E which consists in verifying the true value of the evaluation E. The mode of access is accepted and access to the data is continued in step F for the true value of the evaluation E. Access to the data is not continued in the opposite case when the evaluation E is not verified in step G of FIG. 1.

In this manner, it will be appreciated that each access criterion comprises restriction variables to be applied to the variables of the access rights AR or electronic token carriers PU in order to carry out the implementation of the above-mentioned steps D, E and thus ensure the control of the mode of access required by the registered subscriber.

A specific, non-limiting method of use of the protocol which is the subject-matter of the present invention, in the context of a point-to-point transmission of the data to which access is requested, will now be given with reference to FIG. 2a.

In this case, step C, which consists in establishing an access mode proposition, can consist, in step C1a, in transmitting, from the remote terminal having address j to the central server, an access request which comprises at least the access rights or the electronic token carrier, this request verifying, for example, the relationship (5):
RPⱼ (AR,PU) (5)

In a step C2a, the central server proceeds to the extraction of the rights AR and the electronic token carrier PU and then establishes the access mode proposition for the above-mentioned remote terminal having address j in step C3a, as shown in FIG. 2a. The process is then continued in accordance with steps D, E, F, G of FIG. 1.

A second variant of use of the protocol which is the subject-matter of the present invention will now be described with FIG. 2b.

In the method of use according to the above-mentioned variant, it is indicated that the transmission of the data is carried out in point-to-point mode, an upstream control being carried out at the central server whilst the process for controlling the access mode itself is carried out at each remote terminal having address j.

In the same manner as in FIG. 2a, the authorised user transmits a request for proposition for the mode of access in step C1b and the server carries out the extraction of the rights AR and the electronic token carrier in step C2b.

Step C2b is followed by a test step C3b, known as prevalidation step, which is carried out at the central server and which consists in verifying specific aspects of the validity of the transaction. In step C3b, the prevalidation step can consist, for example, in verifying, in addition to specific parameters for the identification of the subscribing user making the request, the credit status, that is to say, the presence of tokens in the electronic token carrier PU.

In the case of a negative response to the step C3b, the absence of continuation of the access mode is continued in step C4b. In the case of a positive response to step C3b, a step C5b is begun which consists, for example, in defining a quantity QI_{SOIDkj} of data which will be transmitted to the terminal Tⱼ having the address j.

In addition to the above-mentioned quantity of data, a control message designated ECMₖⱼP(ACAR, ACU) is then calculated, this control message naturally containing the access criteria as defined in accordance with the protocol which is the subject-matter of the present invention.

According to a particularly notable feature of the protocol which is the subject-matter of the present invention, the protocol then consists, in a step C6b, in carrying out the transmission, not only of the above-mentioned quantity of data, but also of the control message, to the remote terminal having address j.

The operations which are carried out in steps C5b and C6b are then continued for each successive quantity of data in step C7b, this operation being designated k=k+1, k designating the rank of the quantity of data which is defined and then transmitted to the remote terminal having address j.

It will be appreciated, in particular, that this method of operation is particularly advantageous in the case of a point-to-point transmission according to the IP protocol in so far as the transmission of the data to which access is requested is carried out in batches, the quantity of data QI_{SOKkj} being able to correspond to a given number of batches which can be linked, for example, to the remaining value of the electronic token carrier PU.

On receiving the control message ECMₖⱼP(ACAR, ACU) and the quantity of data QI_{SOIDkj} at the remote terminal having address j, a step C8b is requested in order to calculate the access mode proposition Pₖ (AR, PU, ACAR, ACU), this step being followed by a step Db which consists in carrying out the evaluation for the above-mentioned access mode proposition Pₖ(.). Of course, the process in steps C8b and Db is continued for k=k+1 for each successive quantity of data in step C9b. The process for controlling the access mode can then be continued according to FIG. 1, the continuation of the access mode being carried out as long as the evaluation for each access mode proposition of rank k is evaluated at the true value.

It will be appreciated that the second method of use of the protocol which is the subject-matter of the present invention as shown in FIG. 2b allows, on the one hand, direct management to be carried out for each electronic token carrier PU at the central server owing to the upstream control carried out by means of the prevalidation in step C3b, and, on the other hand, any need to produce a statement of consumption at the remote terminal having address j to be eliminated.

Finally, a simplified version in a third variant of use of the protocol which is the subject-matter of the present invention, will now be described with reference to FIG. 2c, which simplified version relates to the method of use of FIG. 2b.

In FIG. 2c, it is considered, in a step C1c, that the authorised subscribing user is simply sending a request to the server, this request being designated Rⱼ(--). This request can simply comprise the address j of the remote terminal Tj, parameters identifying the requester and justifying his authorisation to interrogate the central server. The above-mentioned request further comprises a reference to the service requested, that is to say, to the data for which access is requested. In this third method of use, the upstream control carried out by the prevalidation step of FIG. 2b is dispensed with. Under these circumstances, a step C2c is requested which corresponds to steps C5b and C6b of FIG. 2b, the step C2c corresponding to the transmission of the quantity of data and the control message previously described with reference to FIG. 2b. Step C2c is reproduced systematically in step C3c designated k=k+1 for the various successive quantities which constitute the group of data supporting the requested service.

On receiving the successive quantities of data at the remote terminal having address j, a step C4c is requested which consists in establishing the access mode proposition in the same manner as in the step C8b of FIG. 2b. Step C4c is followed by a step Dc which consists in carrying out the evaluation of the access mode proposition Pₖ(.) previously described with reference to FIG. 2b. The process is continued for each quantity of data of the rank k by the step C5c, designated k=k+1, as long as the data are transmitted and the evaluation carried out in step Dc is verified at the true value. The process for controlling the mode of access can then be continued by steps E, F and G of FIG. 1 in the same manner as in FIG. 2b.

The method of use according to the third variant of use of FIG. 2c of the protocol which is the subject-matter of the present invention allows the entire evaluation process to be carried out at each remote terminal having address j, the operations at the central server being reduced to their most simple form and consisting in subdividing the support data for the service into successive quantities of information. However, this production variant requires verification or statements of consumption carried out by each authorised subscriber having a remote terminal having address j.

A preferred method of use of the protocol for controlling the mode of access to data, which is the subject-matter of the present invention, will now be described, on the other hand, with reference to FIGS. 3a and 3b in the case of a transmission of these data in point/multipoint mode.

The above-mentioned method of use appears more particularly suitable for use in the field of transmission of broadcast programmes on television, whether these programmes are transmitted in scrambled form, or without encryption.

When the programme data are transmitted in scrambled form, it should be noted, by way of non-limiting example, that these data are transmitted between a transmission centre for scrambled information, the scrambling being carried out by means of a service key which is contained in a control word and the control word being encrypted by means of an operation key. The operation key can then be changed for security reasons, the message for changing the operation key being encrypted by means of a management key during any changing of the above-mentioned operation key. The changes of the encrypted control word and the encrypted operation key are synchronised with scrambled information for transmission to one or more unscrambling terminals. The authorised client users have a subscription and constitute a group having, for example, the address 1. Each remote terminal T₁ where 1 designates the address of this group or, if necessary, the address of a single terminal, when the group is constituted by a single subscriber, is provided with a security processor designated PS₁.

Under these circumstances, and according to a particularly advantageous feature of the protocol which is the subject-matter of the present invention, step A, which consists in establishing each access right AR and each electronic token carrier PU and which is described with reference to FIG. 1, can consist in transmitting, to each unscrambling terminal T₁ and to the access control module associated therewith, in a step A′, messages for managing access rights and electronic token carriers, these messages verifying the relationship (6):
EMM₁ (AR, PU) (6)

In the same manner, the above-mentioned step A′ is followed by a step B′ which allows each access criterion to be established in accordance with step B of FIG. 1 and which advantageously consists in transmitting to each unscrambling terminal T₁ and to the access control module associated with each of these terminals, control messages for the access entitlements which verify the relationship (7):
ECM₁ (ACAR, ACU) (7)

When each remote terminal T₁ and security processor PS₁ associated with each of these terminals receives the above-mentioned messages, the content of these messages, after verification, is stored in the access control module which can then proceed, in step C, to establish the access mode proposition in a similar manner to step C of FIG. 1, then to step D for evaluation of the above-mentioned access mode proposition.

In FIG. 3a, the access mode proposition verifies the relationship (8):
P₁ (AR, PU, ACAR, ACU) (8)
   and the evaluation verifies the relationship (9):
E(P₁(AR, PU, ACAR, ACU)) (9)

The protocol for controlling the access mode is continued in steps E, F, G in the same manner as in FIG. 1. However, the protocol is used at each terminal T₁ and the security processor PS₁ of the access control module associated with each of the terminals.

A more detailed description of a variant of use of the protocol for controlling the mode of access to data, which is the subject-matter of the present invention, will now be described with reference to FIG. 3b, in the more specific case of a point type offer of acquisition of rights to different subscribers, this point type offer being more generally designated, in the context of point/multipoint transmission, as an impulse purchase offer.

This possibility of controlling the mode of access appears particularly advantageous in so far as any subscriber, having an unscrambling terminal T₁ and an access control module which is provided with a security processor PS₁, may be offered, at any time, a possibility for access on the initiative of the broadcasting operator alone.

Under these circumstances, with reference to FIG. 3b, it is indicated that the step which consists in establishing each access right and each electronic token carrier can consist, in a step A″, in transmitting, to each authorised user, messages which verify the relationship (10):
EPM₁ (AR, PU, PD, Cost [PUId, UC]) (10)

These offer messages for an access proposition contain at least the access rights AR or electronic token carriers PU, a variable PD for the date of the proposition or offer, and a cost variable Cost defined based on restrictions on the identification number variable of at least one electronic token carrier PUId and one count unit variable designated UC of the corresponding electronic token carrier(s).

Taking into account the similar encoding of the access rights AR and the electronic token carriers PU, it will be appreciated that the messages which verify the relationship (10) can correspond either:
to an impulse type proposition for acquisition of an access right:
IPAR=Date AR Cost with Cost=CostId PurseId [PurseSubId] CostUnits,
or to a proposition for acquisition of electronic token carriers IPPurse, such as:
IPPurse=Date Purse Cost, with Cost=CostId PurseID [PurseSubId] CostUnits.

In this method of use, it should be noted that Date defines the offer date PD, AR defines the access right as previously defined in the description and Cost defines the cost variable as previously mentioned with the group of parameters, CostId designating a purchase identifier, PurseId designating an electronic token carrier identifier, PurseSubId a subidentifier for an electronic token carrier and CostUnits corresponding to the count unit UC previously defined in the description.

It is indicated that the link between identifiers and subidentifiers and the access mode itself, such as subscription, time fee, inter alia, is then carried out in the form of a reference which is recorded without encryption in the data blocks of the access control module, the module being able to be produced in the form of a microprocessor card, as mentioned previously, in order to allow a non-encrypted presentation to the subscriber by means of simple display. The corresponding data blocks are, however, write-protected under the control of the broadcasting operator.

A more detailed description of specific applications of the protocol for controlling the access mode, which is the subject-matter of the present invention, will now be given with reference to FIGS. 4a to 4d in different situations corresponding to the acquisition of access rights AR, acquisition by means of point type action or by impulse purchase of units by means of an electronic token carrier, the acquisition of a right by means of a point type offer or an offer of an impulse purchase by means of an electronic token carrier and the acquisition, in a point or impulse type manner, of a new electronic token carrier by means of an electronic token carrier held by the subscriber in his access control module or dedicated microprocessor card.

Generally, it should be noted that the different variables which constitute the access rights AR and access criteria AC correspond to encoded values whose reference can be translated in a non-encrypted manner for the purposes of information for the subscribing user.

By way of non-limiting example, it is indicated that the values of the variables can be defined in the following manner:
RightId=subscription/session/geographical group
UnitId=Byte time, time designating a duration
PurseId=token credit/subscription fee/session fee/duration fee/volume fee.

The correspondence between the encoded values of the above-mentioned variables and the reference thereof can be defined in private data, of the text or digital type, for example, in the access control module or microprocessor card and, in particular, in the memory zones of the security processor which equips them.

By way of non-limiting example, the values of the above-mentioned encoded variables and the corresponding reference can be established according to the following table:

TABLE T1

| RightId | Reference |
|---|---|
| 10 | Subscription |
| 20 | Session |
| 30 | Geographical |
| | group |

| | | Conversion | | Associated |
|---|---|---|---|---|
| PurseId | Reference | fee | Unit | deficit |
| 10 | Token credit | 5 | Count unit | 50 |
| 20 | Subscription fee | 1 | Subscription | |
| 30 | Session fee | 1 | Session | |
| 40 | Duration fee | | | |
| 50 | Volume fee | | | |

| | | Conversion | |
|---|---|---|---|
| UnitId | Reference | rate | Unit |
| 0 | Time unit | 10 | Seconds |
| 1 | Volume unit | 1 | Kbytes |

When the above-mentioned table is examined, it will be appreciated in particular that:
the access rights are defined by the identification variables RightId for the rights corresponding to the references subscription, session, geographical group, respectively;
the token carriers are defined by the variable PurseId for the values corresponding to the references token credit, subscription fee, session fee, time fee, volume fee, respectively.

For the electronic token carriers, it is advantageously possible to use a conversion rate, the conversion rate enabling the access mode held by the subscribing user to be modulated in accordance with the access mode granted and the count unit of the information or accessed data, the unit corresponding to monetary count units, for example, Euros or the like, subscription units or numerical units. Finally, a deficit can be associated and granted for specific access modes, such as, for example, the credit fee or the credit of tokens. The value of the associated deficit is given as a real value.

Finally, the access unit variables UnitId can correspond to a time unit reference, during which time access to the information or data is granted or, in units of volume, volume of information or data to which access is granted. In the same manner as for the identification variable for the token carrier, a parameter for a conversion rate is provided, which allows the access mode to be modulated taking into account the unit used, seconds for the unit of time, the Kbyte for the unit of volume, for example.

It will be appreciated in particular that, in the context of a point-to-point transmission, the access unit variable, identifier and subidentifier of an access unit can, for example, correspond to a unit of volume, such as the Kbyte, as previously mentioned in the description.

The unit of time, the second, can, on the other hand, be used for the point/multipoint transmissions in which the transmission is substantially regular and regulated by the periodic sending of ECM messages for changing, for example, the service key or the control word.

In the following description, the different examples illustrated by FIGS. 4a to 4d are given, these examples corresponding to specific methods of use of the evaluation step based on the access proposition step, as previously described in the description for steps D and C of FIG. 1 or the production variants thereof according to FIGS. 2a to 2c and 3a, 3b.

It will be appreciated in particular that, following the selection of the subscribing user, and in accordance with his access mode requirements and the acquisition offers carried out by the broadcasting operator, the proposition for the mode of access allows the evaluation of the access restrictions established to be carried out based on the access criteria ACAR, ACU which are applied to access rights AR or to the electronic token carrier PU.

In the following description, it is indicated that the variables for access rights will be designated by simple designations which correspond substantially to the previous designations, whilst the corresponding access criteria variables will be designated by variables subscripted by the letters AC to indicate that they belong to the definition of the above-mentioned access criteria and to distinguish them, if necessary, from corresponding variables which define the access rights.

Evaluation of Control of Access Mode Based on Criteria by Right of Access as Such. Example According to FIG. 4a.

Control_ACAR:
the above-mentioned access mode criterion is verified, if it exists, in the dedicated file of the access control module of the subscriber, that is to say, of the microprocessor card which he owns or in the remote terminal thereof, an access right verifying the test 40a, according to which the identification of the right designated by the access criterion RightId_{AC} is equal to the identification of the right of the subscriber RightId. In the case of a negative response to this test, a step 40b to end the evaluation for the relevant right FE is requested which can trigger an alarm at the remote terminal or at the unscrambling terminal.

In the case of a positive response to the test 40a, a test 40c is requested which consists in verifying whether the subidentifier of the right of the access criterion RightSubId_{Ac} is equal to the subidentifier of the access right or whether one of the two subidentifiers is not specified.

The test of the step 40c verifies the relationship:
RightSubIdAc=RightSubId or ∃φ.

The notation ∃φ designates the absence of one of the subidentifiers from the preceding relationship.

The test 40c can, if necessary, be carried out in a similar manner on the combination of variable/subvariable RightSubId_{AC}[Level] when the subvariable Level is present.

In the case of a negative response to the test 40c, the step 40b for ending the evaluation for the relevant right FE is requested once more. Conversely, in the case of a positive response to the test 40c, the step 40d is requested which consists in a verification test of the level of the access criterion in comparison with the corresponding level of the access right registered in the card of the subscriber or in the remote terminal thereof. The test 40d verifies the relationship:
L_{AC}≦L or ∃φ. The notation ∃φ indicates that one of the level variables L_{AC} of the access criterion or L of the access right is not specified, this condition being indicated in a similar manner to the test 40c.

In the case of a negative response to the test 40d, the step for ending the evaluation for the relevant right FE of the step 40b is requested. Conversely, in the case of a positive response to the test 40d, the right AR registered in the card is considered to be valid from the point of view of defining the corresponding access mode in comparison with the access criterion designated by the broadcaster of corresponding control messages. The verification steps 40a, 40c, 40d correspond to a verification of the access mode and the compatibility of the access modes registered with the subscriber as an access right in comparison with access criteria transmitted by the ECM control messages.

The process of verification of the above-mentioned access mode is therefore followed, in the case of a positive response to the test step 40d, by a time verification of the access mode under the following conditions: the above-mentioned time verification applies to three different situations depending on whether the right of access AR which is registered in the access control module of the subscriber, or in the terminal thereof, corresponds to a right with fixed dates, to a right having activatable dates or to a right having no date.

It will be appreciated, in particular, that the variable Validity of the access right AR corresponds to a start date and an end date of the right. These dates are generally designated by Dates and the variable Date of each access criterion ACAR, ACU is designated Date_{AC}.

In these circumstances, the time verification of the access mode can consist in carrying out a test 40e which consists in verifying whether the dates Dates which define the validity variable Validity of the access right constitute fixed dates.

In the case of a positive response to the test 40e, a test 40f is requested which consists in verifying whether the date Date_{AC} of the access criterion is, in a broad sense, between the start date and the end date of the above-mentioned access right. The test 40f verifies the relationship:
Date_{AC} εvalidity where validity represents the fixed dates Dates of the registered access right AR.

In the case of a negative response to the test 40f, an evaluation end step 40g, which is similar to the aforementioned step 40b, is requested. This step can comprise an alarm which is intended to inform the subscribing user.

Conversely, in the case of a positive response to the test 40f, the time verification procedure of the access mode is continued by the establishment, in the step 40h, of an evaluation variable designated EVC=1, this variable corresponding to the true value of the evaluation, for example.

Conversely, in the case of a negative response to the test 40e, a return is carried out in order to repeat the time verification of the access mode in order to distinguish the Validity parameter of the registered access right AR, in accordance with activatable dates or the absence of a date.

Under these circumstances, a test 40i is requested which consists in verifying whether the registered access right AR comprises activatable dates. In the case of a positive response to the test 40i, a test 40j is requested which consists in verifying whether the date of the access criterion Date_{AC} is less than or equal to the lapsing date of the registered access right AR. The test 40j verifies the relationship:
DateAC εValidity

In the case of a negative response to the test 40j, an evaluation end step 40k, similar to the previous step 40b, is requested, an alarm being able to be triggered at the remote terminal or unscrambling terminal.

Conversely, in the case of a positive response to test 40j, a step 40l is requested. In the case where the subscriber has given his agreement to the activation of the dates, and therefore with a positive response to the test 40l, the right having an activatable date is activated, that is to say that this right is converted into a right with fixed dates. This operation is carried out in the step 40n, the conversion operation consisting in taking the effective current date Date, which is contained in the access control message, as the fixed start date for validity, taking into account the agreement given by the subscriber. The step 40n can then be followed by a return to the process for verifying the fixed date right criterion, that is to say, by returning upstream of the test 40f, for example, in order to ensure a subsequent management which is similar, for example, to the right with fixed dates created in this manner by the user.

Conversely, in the case of a negative response to the test 40l, the subscribing user not having given his agreement, an agreement request step 40m is requested, this step being followed by a return upstream of the test step 40l in order to continue the process.

It will be appreciated in particular that, in the case of a positive response to the test 40l, following the conversion of the right having an activatable date into a right with fixed dates, the right control generated by the next control message, such as an ECM message, which was previously mentioned in the description and which carries an access criterion, will be verified by means of the verification process for the rights with fixed dates according to the procedure previously described in the description, with the steps 40e, 40f and 40g.

Conversely, in the case of a negative response to the step 40i, with the registered access right AR not comprising a fixed date or activatable date, a verification test 40p is requested, which consists in verifying that the registered right AR is a right with no date, that is to say, a right whose Validity parameter is not specified, the right being able to be validated in this case.

In the case of a positive response to the test 40p, that is to say, in the absence of any specification of the Validity parameter for the registered access right AR, the access control process is continued by the request for the above-mentioned step 40h, no control being carried out on the date of the access criterion transmitted.

In the case of a negative response to the test 40p, an evaluation end step 40q is requested for the relevant right FE.

Verification of the Access Mode Control Based on a Criterion for Each Unit Consumed in an Electronic Token Carrier. FIG. 4b, Purchase_Unit:

The process described with reference to FIG. 4b allows the acquisition of a unit by means of an acquisition operation, such as an impulse purchase, via an electronic token carrier which is stored in the access control module of the subscriber or in the card thereof.

The protocol which is the subject-matter of the present invention appears particularly notable in so far as, owing to the similar encoding method of the electronic token carrier PU and the access rights AR, the same test criteria can be substantially applied to the electronic token carriers and to the registered access rights AR for this reason.

As a consequence, in FIG. 4b, the test steps 40a, 40c and 40d do not relate to the identifiers of the access rights and access criteria or the subidentifiers of access rights and access criteria and the level of the access criteria and access rights, respectively, but instead to the electronic token carrier identifiers, electronic token carrier subidentifiers, and the cost of the acquisition operation of an electronic token carrier, respectively, in comparison with the units remaining in the electronic token carrier registered in the card of the subscriber.

In this manner, the tests having the same references verify the relationships:
40a: PurseId6hd Ac=PurseId, the token carrier identifier transmitted by the access criterion ACU is equal to the token carrier identifier PurseId registered in the card of the subscriber;
40c: the token carrier subidentifier PurseSubIdAc transmitted by the access criterion ACU is equal to the token carrier subidentifier registered in the card PurseSubId where one of the two has no subidentifier, the test 40c verifying the relationship: PurseSubId_{Ac}=PurseSubId or ∃φ, one of the two subidentifiers not being specified.
40d: COSt_{AC}(PUId, UC) with UC≦CO, the cost of the acquisition operation for a right via a token carrier registered in the card is less than or equal to the units CO remaining in the token carrier of the subscriber.

The corresponding verification operation of the access mode having been successful in the case of a positive response to the above-mentioned test 40d, the process is continued by a time verification of the access mode, in the same manner as in FIG. 4a.

By way of non-limiting example, it is indicated that the steps 40e, 40f to 40m, 40p, 40q represent the same test and/or operation steps as in FIG. 4a, the variables Date_{AC} and Validity representing, however, the date of an impulse acquisition of the right by means of an electronic token carrier and the validity variable, respectively.

Under these circumstances, the step 40n of FIG. 4b does not relate to the conversion of the right with fixed dates, as in the case of FIG. 4a, but to the conversion of the electronic token carrier into a token carrier with fixed dates, in operating conditions which are similar to those of FIG. 4a for the registered access right acquired.

Finally, it is indicated that the operation 40l relates to the verification of the agreement of the subscriber to the operation carried out, the agreement request 40m being able to comprise, on the one hand, the agreement request for the activation of the electronic token carrier which is converted into an electronic token carrier with fixed dates and, on the other hand, the agreement request for the definitive purchase of the unit in question.

Following the fulfilment of one of these criteria, in the same manner as in FIG. 4a, step 40h is requested for which the evaluation or the evaluation variable EVC is considered to be true. However, a parameter for consumption of units, designated by archiving of UC, is stored, this parameter being able to be characterised by the identifier and the subidentifier of units originating from the operation and the number of units consumed with the identifier and subidentifier of the electronic token carrier associated therewith. This operation is carried out in step 40ha, prior to the step 40h, for example. Of course, the remaining electronic token carrier units CO are also reduced by the cost of the purchase, this operation being designated in the step 40ha: NCO=CO−UC.

Impulse Purchase of Rights. FIG. 4c, Purchase_AR;

This operation comprises the same steps 40a, 40b, 40c, 40d which allow the implementation of the access mode verification as in FIG. 4b. The different variables represent, for these tests, the same elements as in FIG. 4b.

This applies similarly to the time verification of the access mode for the steps 40e, 40f, 40g, 40h and 40i, 40j, 40k, 40l, 40m and 40n, 40p and 40q corresponding substantially to the same steps having the same references in FIG. 4b.

Owing to the similar encoding of the access rights and access criteria, the step 40ha substantially corresponds to an updating of the remaining units reduced by the cost of acquisition by NCO=CO−UC, as previously mentioned with regard to FIG. 4b.

The step 40ha is then followed by a step 40hb for recording the right itself in the access control module with which the subscriber is provided.

In the test steps 40f and 40j, it is indicated that Validity designates the electronic token carrier validity variable registered in the card and Date_{Ac} designates the date on which the operation is effectively carried out.

Impulse Purchase of Electronic Token Carrier. FIG. 4d, Purchase_PU;

This operation allows the impulse purchase of a new electronic token carrier via an electronic token carrier which is registered in the access control module of the subscriber if the following conditions are met. Generally, it should be noted, owing to the substantially identical encoding of the electronic token carriers PU and the access rights AR, so as to constitute generic rights, that the process shown in FIG. 4d comprises the same access mode verification steps with the tests 40a, 40c, 40d then time verification of the access mode, the steps 40e to 40h, 40i to 40n, 40p, 40q and 40ha being identical to those in FIG. 4c for this reason.

However, the step 40hb for recording the right of FIG. 4c is replaced this time by the step 40hb for recording the new token carrier.

In this manner, it will be appreciated, upon examination of FIGS. 4a to 4c, that the evaluation step for the access right restrictions and acquired electronic token carriers preferably comprises a step for verification of the access mode and the compatibility of the registered rights in comparison with the access criteria, then, in the case of the above-mentioned Figures, a time verification step for the access mode. These steps can be transposed in terms of their sequence without any disadvantage.

The generic access rights and generic access criteria according to the subject-matter of the present invention appear to have a particularly flexible use in so far as they allow particularly advantageous control messages to be implemented. These control messages can be programmable so as to comprise a logical combination of conditions, the binary result of which for the logical verification True or False allows a conditional branching of actions to be brought about, these actions being processed sequentially by the unscrambling terminal or the destination security processor.

It will be appreciated, under these circumstances, that it is possible to combine point type offers or impulse purchase offers owing to the above-mentioned logical combinations, in order to produce complex offers which allow the subscribing users a large degree of flexibility of use.

An example of use of messages of this type comprising two conditions of access, such as, for example, an offer of impulse purchase of a fee, designated fee number A, or consumption based on a fee, designated fee number B, acquired by the subscriber, and a statement of consumption of a fee will now be described with reference to FIG. 5.

Generally, it is indicated that the protocol which is the subject-matter of the present invention, in particular for producing the combination of different access modes, appears particularly suitable for applications with point/multipoint transmission when the data are transmitted in a scrambled manner, as previously described in the description. Of course, a point/multipoint transmission mode of this type is not limiting and it is completely possible to transmit the data without encryption or even in scrambled form, via point-to-point transmission by means of a transmission protocol of the IP type, for example.

As a consequence, with reference to FIG. 5, the protocol which is the subject-matter of the present invention, in this application of a combination of separate modes of access, will be described when the protocol is used from a transmission centre CE to an unscrambling terminal designated T₁ which is equipped with an access control module CAM₁ formed, for example, by a microprocessor card and provided with a security processor PS₁. In conventional manner, the transmission centre CE can advantageously comprise, as shown in FIG. 5, a commercial subscriber management system, designated SGC, which is linked to a management unit for access entitlements GTA, the assembly allowing messages to be generated, known as subscription management messages or EMM messages, standing for Entitlement Management Messages. The EMM messages are transmitted to a message broadcaster DM and a data collector allows the data to be collected which have arrived from each subscriber via a return path, such as, for example, the switched telephone network inter alia. The return path allows the return of fundamental information to be ensured in order, for example, to carry out billing and to thus remunerate the broadcaster or those having such rights. The data collector is, of course, linked directly to the management system for access entitlement GTA.

Finally, a controller of access entitlements CTA generates control messages known as ECM messages, standing for Entitlement Control Messages. All of the EMM messages and ECM messages delivered by the message broadcaster DM or by the CTA, respectively, can therefore be multiplexed with the data in non-encrypted form which, prior to transmission, can be encoded then scrambled in a manner known per se. The transmission to the unscrambling terminal is then carried out either by satellite or by terrestrial cable, for example. The ECM messages containing the cryptogram for the control words can then allow the scrambled data to be unscrambled when received at the unscrambling terminal T₁, taking into account the existence of access rights AR and/or electronic token carriers PU registered in the access control module CAM₁, as previously described in the description.

With reference to FIG. 5, it is indicated that the process for controlling the mode of access which combines two separate modes of access can be accessible by subscription, as will be described below.

By way of non-limiting example, the control of access by subscription can be carried out based on a criterion for each access right, as described with reference to FIG. 4a by a message of the type Control_ACAR.

If the subscriber does not have a corresponding subscription, impulse purchase offers associated with the programme allow access thereto, such as:
the acquisition of the subscription in a fee based on a message for the impulse purchase of rights, as described with reference to FIG. 4c, of the type Purchase_AR.
the acquisition of a subscription fee in order then to be able to access the subscription in the fee, that is to say, according to the combination of messages Purchase_PU, as described previously with reference to FIG. 4d, plus the message Purchase_AR, as described previously with reference to FIG. 4c.

The protocol which is the subject-matter of the present invention therefore consists in synchronising the following messages, ECM messages and EMM messages, the above-mentioned EMM messages being designated EPM messages owing to the offer of an access mode proposed thereby.

The following sequence is therefore transmitted by the transmission centre CE:
the access criteria and the control words CW in the form:
ECM=If Control_ACAR, then Decipher_CW.

It will be appreciated, in particular, that the ECM message comprises the logic combination for unscrambling the control word at the security processor PS₁ which is associated with the unscrambling terminal and the execution of the unscrambling of the control word CW based on the current operation key.
The possibilities for impulse access mode, by means of EPM messages, in the form:
EPM₁=Purchase_AR, as previously described according to FIG. 4c,
EPM₂=Purchase_PU, as described with the FIG. 4d.

The detailed content of the above-mentioned messages is therefore as follows:

TABLE T2

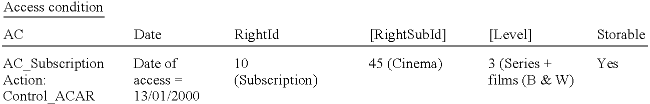

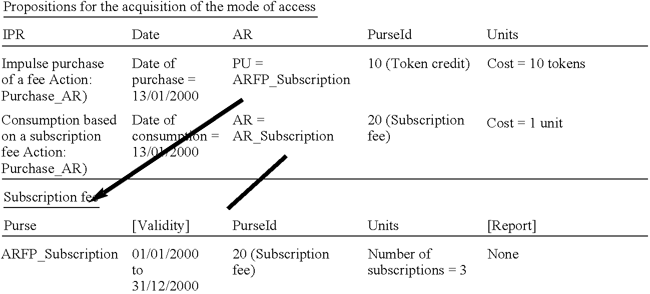

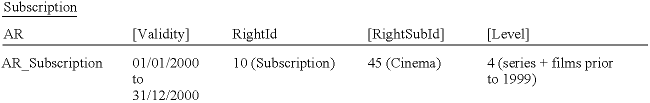

With reference to table T2, it is indicated that the propositions for acquiring an access mode, as described in a detailed manner in the above-mentioned table, correspond to the impulse purchase of a fee previously described with reference to FIG. 4d, or to a proposition for mode of access and therefore for consumption based on a subscription fee. The parameters of the rights of access, that is to say, of token carriers for the corresponding fee or corresponding subscription fee, respectively, are also given in table T2.

With regard to the criteria for the access rights, it is indicated that the variable Storable corresponds to the possibility that the user can record or not.

The process for controlling the access mode will now be described in two separate situations which correspond to the case, on the one hand, in which the subscriber already has the subscription fee and/or, on the other hand, in which the subscriber has no subscription fee, fee number B. In this latter case, the subscriber must acquire the subscription fee, then the subscription in this fee in order to be able to access the transmitted programme.

First Case: the Subscriber Already has Subscription Fee B:

Before the process for controlling the access mode itself, the access control module of the subscriber contains:

TABLE T3
The references and conversion rates in the card (private data)

| RightId | | | Reference | |
|---|---|---|---|---|
| 10 | | | Subscription | |
| | | Conversion | | Associated |
| PurseId | Reference | rate | Unit | deficit |
| 10 | Token credit | 5 | Count unit | 50 |
| 10 | Subscription | 1 | Subscription | |
| | fee | | | |

Subscription fee B

| Purse | [Validity] | PurseId | Units | [Report] |
|---|---|---|---|---|
| ARFP_{—} | 01/01/2000 | 20 | Number of | None |
| Subscription | to | (Subscription | subscriptions = 6 | |
| | 31/12/2000 | fee) | | |

Credit

| Purse | [Validity] | PurseId | Units | [Report] |
|---|---|---|---|---|
| Credit | None | 10 (Token | Number of | None |
| | | credit) | tokens = 50 | |

The sequence of the control of the access mode is therefore as follows:
the subscriber will attribute his access mode in his subscription fee B.
First presentation of the ECM message: the subscriber does not have access to the transmitted data programme since he has no subscription. The unscrambling terminal T₁ carries out a search for the propositions for the access mode by means of impulse purchase associated with the transmitted programme of scrambled data. It presents these propositions to the access control module CAM₁.
   Presentation of EPM Messages for the Impulse Purchase:

Processing of EPM₁, message Purchase_AR, according to FIG. 4c. The proposition for mode of access indicates that the right can be purchased by means of a token carrier PurseId of the type 20 for a cost of 1 according to the conversion rate. In table T3, the notions of reference of unit conversion rates and deficit, if necessary, correspond to the notions previously described in the description. The same applies to the validity variables. In the example given in the card of the subscriber, the subscription fee B corresponds to a token carrier of the type 1, a subscription fee valid on the date of acquisition. There are sufficient units remaining, number of subscriptions=6, the access control module CAM₁ can therefore reply with a request for the agreement of the subscriber and indicating the fee used. The subscriber can therefore acquire the subscription via his subscription fee B.
Second presentation of the ECM message: the subscriber gains access to the programme since he has the subscription.

Following the implementation of the process for controlling the access mode previously described with reference to tables T2 and T3, the access control module CAM, contains: the different data according to table T4:

TABLE T4

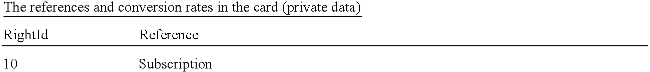

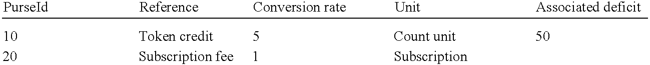

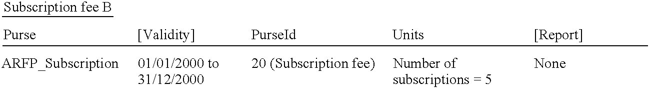

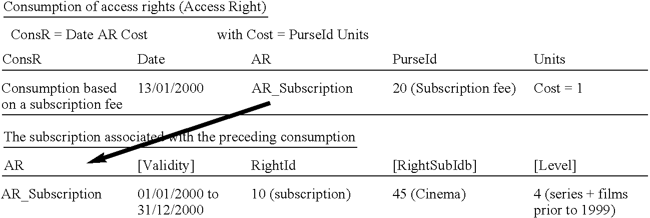

The above-mentioned table T4 comprises the references and conversion rates in the card, in the form of private data, the status of the subscription fee B. It further comprises, in the form of data which cannot be accessed by the user and which are written in italics, the consumption data for access rights which are designated ConsR and in the form Date, right of access AR and Cost for cost, with Cost=PurseId Units.

Finally, the card contains data which relate to the subscription and which are associated with the previous consumption.

The content of the statement is therefore given by the table T5:

TABLE T5

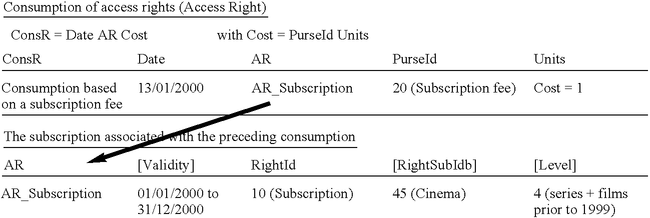

The data in this table can correspond, for example, to the data of consumption of access rights and to the subscription associated with the previous consumption, as previously described with reference to table T4. Of course, these statement contents are not write-accessible by the user and can be transmitted as a consumption statement to the transmission centre CE via the return path.
Second case: the subscriber does not have the subscription fee B which he requires. He must, in this situation, acquire a fee of this type, then the subscription in this fee in order to gain access to the programme of broadcast data.

Prior to the implementation of the corresponding process for controlling the access mode, the access mode module CAM, contains:
the references and conversion rates in the card in the form of private data,
the credit allocated to the electronic token carrier having the identifier PurseId and defined as a number of units in the column Units.

These data are shown in table T6:

TABLE T6
The references and conversion rates in the card (private data)

| RightId | | | Reference | |
|---|---|---|---|---|
| 10 | | | Subscription | |
| | | Conversion | | Associated |
| PurseId | Reference | rate | Unit | deficit |
| 10 | Token credit | 5 | Count unit | |
| 1 | Subscription | 1 | Subscription | |
| | fee | | | |

Credit

| Purse | [Validity] | PurseId | Units | [Report] |
|---|---|---|---|---|
| Credit | None | 10 (token | Number of | None |
| | | credit) | tokens = 50 | |

The sequence of the control of the access mode is as follows:
First presentation of the ECM messages: the subscriber does not gain access to the programme since he does not have a subscription.

The terminal T₁ carries out a search of acquisition propositions in impulse mode associated with the broadcast programme. These propositions are presented to the access control module CAM1.

Presentation of the EPM Messages for Acquisition in Impulse Mode:

Processing of the message EPM₂ of the type Purchase_PU according to FIG. 4b: the acquisition proposition indicates that the subscription fee A can be purchased by means of a token carrier of the type 10 at a cost of 10 count units. In the card dedicated to the subscriber, the credit attributed to the subscriber is no other than a token carrier of the type 10 (see table T6) valid on the date of purchase. The number of units equal to 50 is sufficient. The card of the subscriber replies with a request for agreement indicating the used fee, this request for agreement substantially corresponding to the test operation 40l of FIG. 4c. The subscriber can therefore acquire the subscription fee by means of his credit and he can then purchase the subscription by means of this fee which is also a token carrier of the type 20.

When an agreement is registered for the subscription fee A in the agreement request step 40l, the re-transmission of messages EPM₂ for an impulse purchase brings about the purchase of the subscription fee A with the credit which is debited.

The processing of the message EPM, of the type Purchase_AR is as follows: the proposition for acquisition of the access mode indicates that the right can be acquired by means of a token carrier of the type 20 at a cost of one count unit (see the reference of the corresponding message in table T2).

In the memories of the card or the access control module of the subscriber, there are no electronic token carriers of the type 20, the credit data simply indicating the existence of an electronic token carrier of the type 10, token credit. The access control module CAM₁ replies by notifying the absence of the relevant electronic token carrier. The subscriber cannot therefore acquire the required subscription.
Second presentation of ECM messages: the subscriber gains access to the broadcast programme since, of course, he has the subscription.

Following the use of the protocol for controlling the access mode, which is the subject-matter of the present invention, as previously described, the card contains the following stored information, according to table T7:

TABLE T7

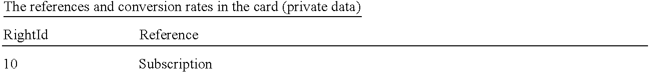

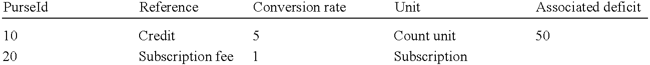

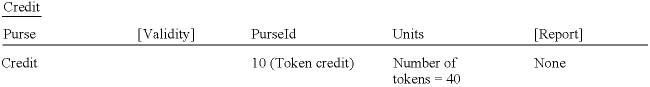

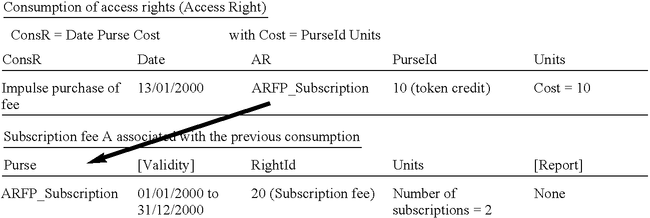

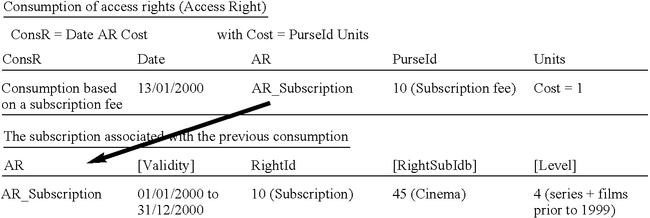

This information comprises the references and the conversion rates in the card in the form of private data.

The credit is allocated to the card, these data being able to be read by the user.

Furthermore, the data stored in the card contain data relating to the consumption of access rights, subscription fee A data associated with the previous consumption and consumption data for the access rights, the subscription fee A associated with the previous consumption and the subscription associated with the previous consumption being clearly set out.

In the same manner as in the previous case, information about the content of the statement can therefore be established according to table T8:

TABLE T8

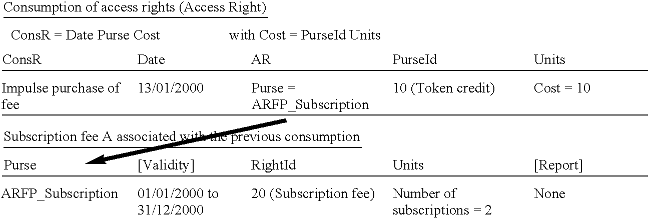

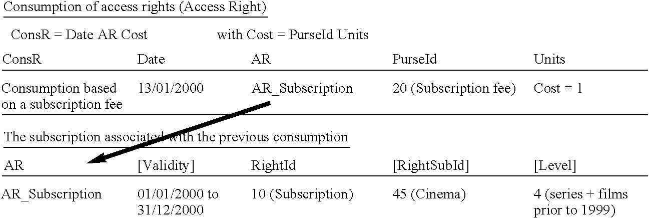

In the same manner as in the previous case, the data of table T8 can correspond to the data for the consumption of access rights, the subscription fee A associated with the previous consumption, the consumption of access and subscription rights associated with the previous consumption, data which are only read-accessible by the user.

In this manner, with reference to the first and the second case previously described, it will be appreciated that a combination of generic access modes can be implemented by means of sychronisation of a succession of ECM messages and EMM messages. Under these circumstances, a control of the access mode for each criterion per unit of quantity of data accessed can be brought about based on an access mode for each criterion per nominal access right, by means of an acquisition proposition in impulse mode for the access right, or the electronic token carrier, respectively.

1. Protocol for controlling the mode of access to data based on access rights and access criteria, the control of the mode of access being subjected to a condition of validity of at least one access right or one electronic token carrier, characterized in that it consists in:
establishing each access right and each electronic token carrier which are acquired by an authoized user in the form of a first group of variables constituted by independent variables and linked variables, the independent variables containing at least one validity duration variable and one identification number variable for each access right or each electronic token carrier, respectively;
establishing each access criterion in the form of a second group of variables constituted by independent variables and linked variables, the independent variables containing at least one access date variable, one identification variable for the access criterion type and one identification number variable for the access right or electronic token carrier;
establishing a proposition for the mode of access to the data in the form of a logic combination group for access criteria in order to define access restrictions;
subjecting the access mode proposition to an evaluation of the access restrictions in comparison with the access rights and electronic token carriers acquired, the mode of access being accepted and access to the data being continued for the true value of the evaluation and the mode of access and access to the data not being continued otherwise.

2. Protocol according to claim 1, characterized in that each access criterion further comprises restriction variables to be applied to the variables for the access rights or electronic token carriers.

3. Protocol according to claim 1, characterized in that the identification variable for the access criterion type designates a criterion per nominal access right or a criterion per unit of the accessed quantity of data.

4. Protocol according to any one of claim 1, characterized in that, for a point-to-point transmission between a central server and a remote terminal, the step consisting in establishing a proposition for mode of access at least consists in:
transmitting, from the remote terminal to the central sever, an access request comprising at least the access rights or electronic token carrier, and, at the central server, —establishing the proposition for mode of access to the data based on the access rights and access criteria in order to define the access restrictions.

5. Protocol according to any one of claim 1, characterized in that, for a point-to-point transmission between a central server and a remote terminal, the step consisting in establishing a proposition for mode of access at least consists in:
transmitting, from the remote terminal to the central server, an access request comprising at least the access rights or electronic token carrier, and, at the central server,
subjecting the access rights or electronic token carriers transmitted to a prevalidation test; and, in response to a verified prevalidation test criterion,
generating a current quantity of data and an access control message which is specific to this current quantity of data and which contains at least the access control criteria;
transmitting, from the central server to the remote terminal, the current quantity of data and the access control message; and
continuing, by iteration, the steps consisting in generating a quantity of data for a following quantity of data and an access control message which is specific to this following quantity of data as long as the prevalidation test criterion is verified; and, at the remote terminal, —establishing the proposition for mode of access based on the access criteria and the access rights for each successive quantity of data received,
subjecting each successive proposition for mode of access to the evaluation, access to the data being continued for any receipt of a current quantity of data and a specific control message which is associated with this quantity of data.

6. Protocol according to claim 1, characterized in that, the protocol being used for point/multipoint transmission between a centre for sending scrambled information by means of a service key contained in a control word, the control word encrypted by means of an operation key and the operation key encrypted by means of a management key in the case of a change and synchronized with the scrambled information for transmission to at least one unscrambling terminal which is associated with an access control module which is provided with a security processor, the protocol further consists in:
transmitting, to the unscrambling terminal and the access control module, messages for managing access rights and the electronic token carrier, EMM messages, comprising the access rights or the electronic token carrier;
transmitting, to the unscrambling terminal and the access control module, messages for controlling access entitlements, ECM messages, comprising the access control-criteria.

7. Protocol according to claim 1, characterized in that the protocol further consists in verifying the value of the access date variable, the identification variable for the type of access criterion and the identification number variable for an access right, in comparison with the corresponding variables of the access rights or electronic token carriers.

8. Protocol according to any claim 1, characterized in that the step consisting in establishing each access right and each electronic token carrier consists in transmitting to each authorized user messages containing at least the access rights or electronic token carriers, a proposition date variable, a defined cost variable based on restrictions on the identification number variable for at least one electronic token carrier and a variable for values of count units of this or these electronic token carrier(s).

9. Protocol according to claim 1, characterized in that, following the acceptance of the mode of access to the scrambled data, the protocol further consists in:
establishing a consumption variable for the accessed quantity of data or rights, respectively, or electronic token carriers in the form of a group of variables constituted by independent variables and linked variables, the independent variables containing at least the variables which constitute the proposition for mode of access,
updating, refreshing, the electronic token carrier in accordance with the consumption variable.

10. Protocol according to claim 9, characterized in that the consumption variable for the accessed quantity of data comprises, in accordance with the type of access criterion:
a consumption variable for access rights or
a consumption variable for count units.

11. Protocol according to claim 1, characterized in that the access rights further comprise a linked subidentifier variable and a linked level variable, the linked variables being optional.

12. Protocol according to claim 1, characterized in that the electronic token carriers further comprise a linked subidentifier variable and a linked report variable for the content of the electronic token carriers, the linked variables being optional.

13. Protocol according to claim 3, characterized in that the access criterion for each nominal access right further comprises a linked subidentifier variable and a linked level variable, the linked variables being optional.

14. Protocol according to claim 3, characterized in that the access criterion for each unit of accessed quantity of data further comprises a linked subidentifier variable for an access unit and a linked variable for the maximum cost which designates a ceiling from which the verification of the access criterion is followed by an authorization in the absence of payment or refusal of access, the linked variables being optional.

15. Protocol according to claim 1, characterized in that the step for evaluating the restrictions on the access rights and electronic token carriers acquired comprises at least: —one verification step for the mode of access and the compatibility of the registered access rights in comparison with the access criteria and
one time verification step for the mode of access, the steps being able to be transposed.

16. Protocol according to claim 1, characterized in that the duration of validity of each registered access right and each electronic token carrier is encoded according to a type of date, fixed dates, activatable dates or absence of date specification.

17. Protocol according to claims 15, characterized in that the time verification step for the mode of access consists at least in
distinguishing the type of date, fixed dates, activatable dates or absence of date specification, the distinguishing of the type of activatable dates being followed, after verification of the validity of the date belonging to this type of date, by a step consisting in:
converting the access right or electronic token carrier with an activatable date into a right or electronic token carrier with fixed dates which allows the access right or the electronic purse then to be processed in accordance with a corresponding right or an electronic purse with fixed dates.

18. Protocol according to claim 17, characterized in that the step which consists in converting the access right or electronic token carrier is conditional on the agreement of the subscriber with regard to this conversion.

19. Protocol according to claim 1, characterized in that it comprises a combination of modes of access, used on the basis of programmable control messages so as to comprise a logical combination of conditions, the binary result of which for the logical verification True or False allows a conditional branching of actions to be brought about.

20. Protocol according to claim 6, characterized in that, for a point/multipoint transmission of scrambled data to at least one unscrambling terminal which is provided with an access control module which comprises a security processor, and for carrying out a combination of generic modes of access, the protocol consists in synchronizing a series of access control messages, ECM messages, and messages for managing access entitlements, EMM messages, which allows control of the mode of access to be carried out per criterion per unit of quantity of data accessed on the basis of a criterion per nominal access right, by means of a proposition for acquiring in an impulsive manner an access right or electronic token carrier.
